(19) United States
(12) Patent Application Publication
(10) Pub. No.: US 2024/0105103 A1
(43) Pub. Date: Mar. 28, 2024

(54) METHOD FOR DRIVING A THIN FILM ELECTROLUMINESCENT DISPLAY AND ARRANGEMENT FOR DRIVING A THIN FILM ELECTROLUMINESCENT DISPLAY

(71) Applicant: Lumineq Oy, Espoo (FI)

(72) Inventors: Mika SIRKIÄ, Espoo (FI); Alexey GANZHINOV, Espoo (FI)

(21) Appl. No.: 18/038,492

(22) PCT Filed: Nov. 26, 2021
(86) PCT No.: PCT/FI2021/050811

§ 371 Date: May 24, 2023

(30) Foreign Application Priority Data
Nov. 27, 2020 (FI) 20206209

(51) Int. Cl. G09G 3/30; H05B 33/26

(52) U.S. Cl. CPC G09G 3/30; H05B 33/26; G09G 2300/0426; G09G 2300/0842; G09G 2310/08; G09G 2320/0233; G09G 2320/0247; G09G 2330/021

(57) ABSTRACT

A method for driving a TFEL display (100) is disclosed. The method includes, in the following order, the steps of: a) launching, in a launching step (301), a driving voltage signal (201) from a zero voltage to the amplitude voltage (201a) for launching a driving voltage pulse (173), b) holding, in a holding step (302), the driving voltage signal (201) between the common electrode driving node (125a) and the segment electrode driving node (126a) in the amplitude voltage (201a), and c) cutting, in a cut-off step (303), the driving voltage signal (201) to a zero voltage after the thin film structure of the TFEL display (100) has been charged to a threshold charging (280t) capable of generating a secondary light emission (295b) from the thin film structure. An arrangement for driving a TFEL display (100) is also disclosed.

### FIELD OF THE INVENTION

The present invention relates to a method for driving a thin film electroluminescent display (herein, referred to as a “TFEL” or “TFEL display”) and more particularly to a method according to preamble of claim 1. The present invention also relates to an arrangement for driving a thin film electroluminescent display and more particularly to a method according to preamble of claim 10.

### BACKGROUND OF THE INVENTION

TFELs are an important subtype among various display technologies. First TFELs date back to 1980s. These displays are robust, withstanding severe environmental conditions during usage and manufacture (e.g. placement into an industrial glazing laminate like a car windshield) and, where needed, have excellent transparency characteristics. Recently transparent TFELs have emerged in optical applications, for example for the use case of showing information in the optical path of gunsights, telescopes and binoculars. Such applications are prone to handheld use cases, requiring almost always a battery powered operation.

TFELs are often classified as high-voltage devices as the luminescent output of the display is excited with a pulsed voltage with amplitudes reaching 200V or even more. TFEL light output is mostly determined by its thin-film composition and the colour of the light mostly by the dopants embedded in the phosphor layer. Most TFEL displays utilize the voltage level of 200V in the driving signals, but there are also thin film structures with a bit more modest light output at 80V level. In general, the higher the voltage, the more power can be converted into light, but the risk of an electric breakdown and the low availability of electrical components at high voltage levels become challenges in such designs.

TFELs, especially transparent TFELs, are reaching several new application areas. However, this generates problems in the prior art. Placing a transparent display to the optical sight of e.g. a gunsight or an aim-scope enables showing of information directly to the optical path without the need of complex arrangements e.g. with reflective surfaces or prisms that can attenuate the light traveling through the optical device considerably. In such applications, the ability to operate the display with low power and in greatly varying lighting conditions, from night-time operations to broad daylight, pose challenges to the power budget and to the ability to control the brightness of the display.

In the prior art, there has been two major ways in controlling the brightness of the display, driving voltage pulse amplitude and driving frequency of the driving voltage pulses. Both approaches have shortcomings. With voltage amplitude control, the emission brightness from different areas of the display can start to be non-uniform, and it is best to keep the amplitude of the driving voltage pulses close to the maximum value to avoid non-uniformity. It is also well known that within a range of driving frequencies (driving frequency is the inverse of the driving pulse period), the brightness of the display is directly proportional to the driving frequency. However, with low frequencies the display can start to flicker due to the ability of the sense of vision to tell the driving pulses apart. In high frequencies, there is an upper limit after which the display electrodes do not have enough time to get charged for light emission. Thus, in summary, there is a need to have more control related to the brightness of the display and the way energy is converted into light for power optimisation and saving. Ultimately, brightness control and ability to meet various power requirements are a question of the control of the ways light is generated in a TFEL display.

### BRIEF DESCRIPTION OF THE INVENTION

An object of the present invention is to provide a method and an arrangement for driving TFELs so that the prior art disadvantages are solved or at least alleviated.

The objects of the invention are achieved by a method characterized by what is stated in the independent claim 1. The objects of the invention are further achieved by an arrangement characterized by what is stated in the independent claim 10.

The preferred embodiments of the invention are disclosed in the dependent claims.

As an aspect of the present invention, a method for driving a thin film electroluminescent (“TFEL”) display is disclosed. The TFEL display comprises a TFEL display panel comprising a stack of a first electrode layer comprising a common electrode, a first dielectric layer, a phosphor layer, a second dielectric layer, and a segment electrode layer comprising a segment electrode. The common electrode and the segment electrode are at least partially overlapping in an overlapping area along a base plane. The TFEL display comprises a driver electronics unit comprising a common electrode driving node, and a segment electrode driving node. The TFEL display panel comprises a display electrode capacitor, and the display electrode capacitor comprises the overlapping area of the segment electrode and the common electrode, part of the first dielectric layer bounded by the overlapping area, part of the phosphor layer bounded by the overlapping area, part of the second dielectric layer bounded by the overlapping area, and an electrode threshold voltage required for a primary light emission. The TFEL display panel comprises a first dielectric layer-phosphor layer interface between the first dielectric layer and the phosphor layer, and a second dielectric layer-phosphor layer interface between the second dielectric layer and the phosphor layer. The TFEL display panel comprises an inner capacitor, the inner capacitor comprising part of the first dielectric layer-phosphor layer interface bounded by the overlapping area, part of the phosphor layer bounded by the overlapping area, and part of the second dielectric layer-phosphor layer interface bounded by the overlapping area. TFEL display comprises a common electrode connection arranged to electrically connect the common electrode with the common electrode driving node, and a segment electrode connection arranged to electrically connect the segment electrode with the segment electrode driving node. According to an aspect of the invention, the method comprises generating, in the driver electronics unit, a driving voltage signal between the common electrode driving node and the segment electrode driving node, the driving voltage signal comprising driving voltage pulses each having a driving pulse period and an amplitude voltage. The method comprises, in the following order, during the driving pulse period, the steps of:
a) launching, in a launching step lasting a launching time, the driving voltage signal from a zero voltage to the amplitude voltage for launching the driving voltage pulse and for commencing a charging of the inner capacitor,
b) immediately after the launching step, holding, in a holding step lasting an on-time, the driving voltage signal between the common electrode driving node and the segment electrode driving node in the amplitude voltage for continuing the charging of the inner capacitor, and
c) immediately after the holding step, cutting, in a cut-off step lasting a cut-off time, the driving voltage signal to a zero voltage, the cut-off step starting after the inner capacitor has been charged to a threshold charging capable of generating a secondary light emission from the inner capacitor.

The advantage of the method above is that with the secondary light emission thus generated, the brightness and energy consumption of the TFEL display can be better controlled.

Also in steps a) and c) above, the driving voltage signal is the voltage between the common electrode driving node and the segment electrode driving node, connected to the TFEL display panel with the common electrode connection and the segment electrode connection.

According to an embodiment, in the method for driving a TFEL display, the inner capacitor comprises an inner threshold voltage required for light emission, and the cut-off step starts after a voltage of the inner capacitor exceeds the inner threshold voltage capable of generating a secondary light emission from the inner capacitor. The advantage of this embodiment is again that with the secondary light emission thus generated, the brightness and energy consumption of the TFEL display can be better controlled.

According to an embodiment, in the method for driving a TFEL display, the duration of the launching time is 1 μs-10 μs, and the amplitude voltage of the driving voltage pulse is equal or more than the electrode threshold voltage. Such a launching time can be considered “fast”, and it leads to a generation of two emissions for one driving pulse period, and thus a brighter emission with the indicated amplitude voltage.

According to an embodiment, in the method for driving a TFEL display, the duration of the on-time is 250 μs-40 ms, more preferably 1 ms-20 ms, or most preferably 2 ms-10 ms. Such an on-time can be considered “long”, and it leads again to a generation of two emissions for one driving pulse period, and thus a brighter emission.

According to an embodiment, in the method for driving a TFEL display, the duration of the driving pulse period is 1%-500% longer than a combined duration of the on-time and launching time, more preferably 10%-50% longer than a combined duration of the on-time and launching time, or most preferably 20%-30% longer than a combined duration of the on-time and launching time. These durations are again advantageous in achieving a bright emission. According to an embodiment, the duration of the launching time is long enough to suppress the primary light emission from the display electrode capacitor. This duration is advantageous in achieving and controlling a dim emission.

According to an embodiment, the duration of the launching time is such that the peak luminance of the primary light emission from the display electrode capacitor is less than the peak luminance of the secondary light emission from the inner capacitor during the driving pulse period. This duration is advantageous in achieving and controlling a dim emission.

According to an embodiment, in the method for driving a TFEL display, the duration of the launching time is 1 ms-20 ms, or the duration of the launching time is more preferably 2 ms-10 ms, or the duration of the launching time is most preferably 4 ms-8 ms. These durations are advantageous in achieving and controlling a dim emission.

According to an embodiment, in the method for driving a TFEL display, the duration of the on-time is 1%-20% of the launching time, more preferably 2%-10% of the launching time, or most preferably 5%-8% of the launching time. These durations are again advantageous in achieving and controlling a dim emission.

According to an embodiment, in the method for driving a TFEL display, the duration of the driving pulse period is 1%-50% longer than a combined duration of the on-time and launching time, more preferably 4%-20% longer than a combined duration of the on-time and launching time, or most preferably 10%-15% longer than a combined duration of the on-time and launching time. These durations are again advantageous in achieving and controlling a dim emission.

According to an embodiment, in the method for driving a TFEL display, the amplitude voltage of the driving voltage pulse is equal or more than the electrode threshold voltage and less than 130% of the electrode threshold voltage, or the amplitude voltage of the driving voltage pulse is equal or more than the electrode threshold voltage and less than 110% of the electrode threshold voltage. These voltages are advantageous in achieving and controlling a dim emission.

As another aspect of the present invention, an arrangement for driving a thin film electroluminescent (“TFEL”) display is disclosed. The TFEL display comprises a TFEL display panel comprising a stack of a first electrode layer comprising a common electrode, a first dielectric layer, a phosphor layer, a second dielectric layer, and a segment electrode layer comprising a segment electrode, the common electrode and the segment electrode at least partially overlapping in an overlapping area along a base plane. The TFEL display comprises a driver electronics unit comprising a common electrode driving node, and a segment electrode driving node. The TFEL display panel comprises a display electrode capacitor, the display electrode capacitor comprising the overlapping area of the segment electrode and the common electrode, part of the first dielectric layer bounded by the overlapping area, part of the phosphor layer bounded by the overlapping area, part of the second dielectric layer bounded by the overlapping area, and an electrode threshold voltage required for light emission. The TFEL display panel comprises a first dielectric layer-phosphor layer interface between the first dielectric layer and the phosphor layer, and a second dielectric layer-phosphor layer interface between the second dielectric layer and the phosphor layer. The TFEL display panel comprises an inner capacitor, the inner capacitor comprising part of the first dielectric layer-phosphor layer interface bounded by the overlapping area, part of the phosphor layer bounded by the overlapping area, and part of the second dielectric layer-phosphor layer interface bounded by the overlapping area. The TFEL display comprises a common electrode connection arranged to electrically connect the common electrode with the common electrode driving node, and a segment electrode connection arranged to electrically connect the segment electrode with the segment electrode driving node. The driver electronics unit is arranged to generate a driving voltage signal comprising driving voltage pulses each having a driving pulse period and an amplitude voltage, the driving voltage signal being generated between the common electrode driving node and the segment electrode driving node. The driving voltage signal is arranged according to the inventive method and its embodiments as defined above. This arrangement is advantageous in arranging a TFEL display with a broad brightness scale between a very dim and very bright display.

As an embodiment, in an arrangement for driving a thin film electroluminescent (“TFEL”) display, the phosphor layer comprises one or more embedded dielectric layers, or the phosphor layer comprises one or more embedded aluminium oxide layers, or the phosphor layer comprises one or more embedded aluminium oxide-titanium oxide nanolaminate layers. Arranging such dielectric layers into the TFEL display panel, into its phosphor layer, helps in setting the brightness characteristics of the display even further.

An advantage of the invention is that with the secondary light emission, a new light generation mechanism becomes available in TFEL displays, allowing much wider control of the brightness. Secondary light emission does not require virtually any extra power to be generated, thus also saving energy. With the secondary light emission, it is possible to increase the brightness of light generated to augment the light generation of the primary pulse, or alternatively generate light only with the secondary pulse to facilitate a dim display, allowing much greater control of light emission also at the dim end of the brightness scale.

### BRIEF DESCRIPTION OF THE DRAWINGS

The invention is described in detail by means of specific embodiments with reference to the enclosed drawings, in which

FIG. 1 shows a prior art TFEL display with peripheral systems,

FIG. 2a shows a prior art driving scheme in terms of the physical phenomena for a TFEL display,

FIG. 2b shows a prior art driving scheme for a TFEL display highlighting the role of the inner capacitor structure,

FIG. 2c shows a timing diagram and pulse forms of a prior art driving scheme for a TFEL display,

FIG. 3 shows a driving scheme according to an aspect of the present invention in terms of the physical phenomena for a TFEL display,

FIG. 4 shows a timing diagram and pulse forms of a driving scheme according to an embodiment of the present invention,

FIG. 5 shows a timing diagram and pulse forms with highlight on the method steps of a driving scheme according to another embodiment of the present invention,

FIG. 6 shows a timing diagram and pulse forms with highlight on the method steps of a driving scheme according to yet another embodiment of the present invention,

FIG. 7 shows results of brightness measurements of a TFEL display when the display is driven according to an embodiment of the present invention, and

FIGS. 8a-8c show embodiments related to the phosphor layer of the TFEL display, advantageous in further adjusting the optical and luminescent characteristics of the display.

### DETAILED DESCRIPTION OF THE INVENTION

In the following description and in the referenced Figures, same labels (e.g. 184b) or same numbers (e.g. 126) denote same elements and features of the invention and its embodiments throughout the present application.

Throughout the present application, the word “connect” or “connected” means, unless otherwise specified, that the connected items are electrically connected with an intended, non-parasitic electrical connection. The connection can be a galvanic connection (short circuit), or may comprise one or more circuit elements, or be electrically otherwise functional.

Throughout the present application, the concepts “voltage node” and “circuit node” are used interchangeably. A “voltage node” or a “circuit node” is an equipotential conductor area (e.g. a pin of a connector), the voltage of which possibly varies in time as a device operates.

The concept of “driving”, in the present application, means the generation of suitable electrical signals to a display panel of a display that cause the display panel to emit light or not emit light (be turned on and off) from one or more picture elements at any given time for information showing purposes.

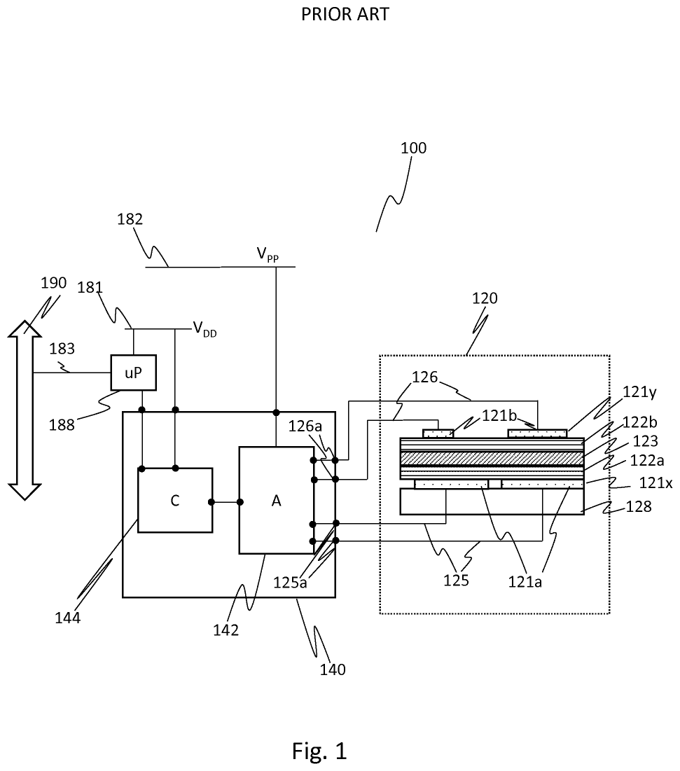

FIG. 1 shows schematically a prior art TFEL display 100. The basic architecture of a TFEL display is usually partitioned into three major blocks, a TFEL display panel 120, a driver electronics unit 140, and a control unit 188.

In FIG. 1, as a schematic side cut-out view, the TFEL display panel 120 comprises usually a substrate 128 on which a thin film structure is deposited. The substrate may be a suitably transparent material like glass, e.g. soda-lime or aluminium silicate glass, or a ceramic material or a plastic which withstands the relatively high manufacturing process temperatures associated with the TFEL display manufacture. Substrate 128 may have one or more additional layers deposited on the surface of the substrate, e.g. a thin transparent ion barrier layer for blocking sodium ions from leaching to the functional (e.g. light generating) layers of the display, arranged with aluminium oxide and deposited with an atomic layer deposition method.

The thin film structure comprises a first electrode layer 121x comprising one or more common electrodes 121a. Common electrodes 121a may be manufactured e.g. by depositing an electrically conductive, yet in terms of the operation of the display, sufficiently transparent thin layer like an indium doped tin oxide (“ITO”) layer on the substrate and then etching patterns on the conductive thin layer to provide electrodes and electrical connections or interconnecting traces coupling the driving voltage signal to the one or more common electrodes 121a from the contact area of the TFEL display panel 120 (contact area not shown in FIG. 1). Deposition of the indium doped tin oxide layer can be arranged e.g. with sputtering. Suitable thicknesses of the indium doped tin oxide layer comprising the common electrodes is e.g. 350 nm (nano meter), or a range between 300 nm-800 nm. The thicker the indium doped tin oxide layer is, the more conducting the electrodes and interconnecting traces are, but the less transparent and optically clear the layer also is.

On top of the common electrodes 121a, a first electrically insulating layer 122a or a first dielectric layer 122a is deposited. Purpose of this layer is to stop a direct current from running over the thin film stack, as this kind of current would be very strong and likely destroy the structure. The dielectric layer 122a is preferably deposited with an atomic layer deposition method (“ALD”) as the requirements of the pin-hole free nature of the film are very high due to the risk of an electric breakdown. Transparency is also a key feature. One suitable combination of materials for the dielectric layer 122a is a nano-laminate (a stratified thin-film stack) of aluminium oxide and titanium oxide, having excellent electrically insulating qualities.

On top of the electrically insulating layer or a dielectric layer 122a, a phosphor layer 123 is deposited or otherwise arranged. This layer is the luminescent layer capable of light production, when so-called hot electrons collide with dopant atoms, excited in motion with the high voltage (and thus, high electric field between the thin films). Suitable materials for phosphor layer are e.g. ZnS:Mn or ZnS:Tb (manganese or terbium doped zinc sulfide) for primarily yellow and green light outputs, respectively. ALD is again an advantageous method for depositing the phosphor layer 123.

On top of the phosphor layer 123, a second electrically insulating layer or a second dielectric layer 122b is deposited. In composition and in the way the layer is arranged, this layer 122b may be identical to the layer 122a, and its purpose is the same as with layer 122a.

Finally, on top of the second electrically insulating layer 122b, one or more segment electrodes 121b and interconnecting traces are arranged on the second electrode layer 121y. As with common electrodes 121a, one or more segment electrodes 121b may be arranged by first depositing a conductive thin layer, e.g. a layer of transparent, yet electrically conductive indium doped tin oxide on top of the second dielectric layer 122b, and then etching and masking suitable patterns on the second electrode layer 121y with lithographic techniques. If both the first electrode layer 121x and the second electrode layer 121y are transparent (making the related common electrodes 121a and segment electrodes 121b transparent, respectively), the display is also transparent. It is also possible to arrange either the first electrode layer 121x or the second electrode layer 121y to be non-transparent, e.g. by arranging said layer of thin metallic aluminium e.g. by sputtering. If both the first electrode layer 121x and the second electrode layer 121y would be non-transparent, the light would be trapped inside such a TFEL display and virtually no light output would be available for information showing purposes.

Common electrodes 121a are called “common” because they may serve a group of segment electrodes 121b overlapping a common electrode 121a. It is possible e.g. to provide only one common electrode 121a to the TFEL display panel 120. Alternatively, at the other end of the segment-common electrode grouping, every segment electrode 121b may have its dedicated common electrode 121a. The electrodes may naturally be placed in any orientation or shape, e.g. comprise finger or strip-like rows and columns, resulting in a passive matrix TFEL.

As said, in a prior art TFEL display, light production occurs where segment electrodes 121b and common electrodes 121a overlap, and a suitably high voltage is applied from segment electrode 121b to common electrode 121a in an alternating or pulsed fashion. This type of display is commonly called the AC (alternating current) TFEL. A suitable voltage pulse amplitude from segment to common electrode can be e.g. 200V. Naturally, the voltage of the pulse can be also e.g. −200V, as in the negative case, the high (e.g. 200V) voltage may applied to the common electrode, and the segment electrode is held at a zero potential. Any other voltage value and feeding arrangement is also possible to the electrodes, as long as the voltage difference between the segment and common electrodes is arranged according to the needs of light emission.

To turn off light production from a segment-common electrode combination, the voltage difference of the amplitude of the driving pulses over the electrodes (that is, from segment electrode to common electrode or vice versa) must be lowered below an electrode threshold voltage. This voltage is typically at a level of 120V-140V, depending on the thickness of the thin film structure. Thus, the shape of the light producing area like a symbol or pixel (square picture element in matrix displays) is defined by the shape of the segment and common electrode overlap as this defines the area or shape where hot electron excitation and travel occurs, perpendicular to the surfaces of the thin film structure.

Electrode connections, specifically one or more common electrode connections 125 and one or more segment electrode connections 126, are arranged to provide the electrical connections between the driver electronics unit 140 and the TFEL display panel 120. Specifically, a segment electrode connection 126 is arranged between a segment electrode driving node 126a of the driver electronics unit 140, and a segment electrode 121b. A common electrode connection 125 is arranged between a common electrode driving node 125a of the driver electronics unit 140, and a common electrode 121a.

The one or more common electrode connections 125 and the one or more segment electrode connections 126 may comprise conductive traces on the first and second electrode layers 121x and 121y, respectively, cablings like flexible printed circuits (FPCs), electrical connectors like lead frame connectors, mating connectors, solders, bonding wire structures, or one or more connecting pad areas, or any combination thereof in a series or parallel electrical connection to connect the driving signals generated by the driver electronics unit 140 to the TFEL display panel 120.

Turning to unit 140 in FIG. 1, a driver electronics unit 140 is depicted schematically. Purpose of the driver electronics unit 140 is to provide driving signals to the TFEL display panel 120 so that at any one time, a desired combination of the segments or pixels is lit on the display, said segments and pixels defined by the overlapping areas of segment and common electrodes. For this end, the driver electronics unit comprises a high voltage unit 142 for driving signal generation and a low voltage unit 144 for the internal control e.g. of the high voltage unit 142 inside the driver electronics unit 140. Units arranged to perform all or most of the functionality of the driver electronics unit 140 are readily available commercially. One example is the HV509 chip available from Supertex Inc. or Microchip Inc. The HV509 chip is a 16-channel serial to parallel converter with a high voltage backplane driver and push-pull outputs capable of 200V, 16 channel output. Several HV509 chips can be cascaded for the output of over 16 channels. Herein, one channel means one segment electrode connection 126 combined with a common electrode connection 125.

Further, the driver electronics unit 140 is arranged to be controlled with a control unit 188. Control unit 188 may comprise a microprocessor, a micro controller, an ASIC or an FPGA chip that is arranged to control the driver electronics unit 140 based on the input received from an information signal connection 183, connected to some interface or communications bus 190 so that the TFEL display 100 may show the output it is arranged to show based on the information in the interface or communications bus 190. The communications bus 190 may be e.g. a CanBUS bus carrying data on the speed of a vehicle (not shown) the TFEL display 100 is arranged into. The TFEL display 100 may comprise three seven-segment display patterns on the TFEL display panel 120. Control unit 188 may be arranged to interpret the message in the CanBUS containing the speed information and turn on (make emit light) and turn off (remain dark) certain segments of the three seven-segment display patterns so that the information on speed (in units like km/h) is shown to the user of the TFEL display 100. Alternatively, the communications bus 190 may be a data interface of an aiming system of a firearm (not shown), and the three seven segment display patterns are arranged to show the distance information to the aiming point of the aiming system in the optical path of the aim-scope of the aiming system, said distance information supplied by the communications bus 190 and provided with other dedicated units of the aiming system. Still alternatively, the control unit 188 may self-generate all or most of the information shown on the TFEL display 100, e.g. when the TFEL display 100 performs the functions of a clock showing time.

Finally, the prior art TFEL display 100 comprises two voltage nodes, a supply voltage node 181 (V_{DD}) and a high voltage node 182 (V_{PP}). Voltage of the supply voltage node 181 may be e.g. from 1.5V to 12V. Voltage of the high voltage node 182 may be e.g. 80V-220V, or 190V-205V. Voltage to the voltage nodes 181 and 182 may be generated inside the TFEL display 100 with voltage conversion technologies like choppers, DC-AC-converters, DC-DC-converters, AC-DC-converters and transformers, or the voltage may be supplied to the TFEL display 100 from external sources. There may be also a negative high voltage node supplying e.g. −200V to the driver electronics unit 140 (negative high voltage node not shown).

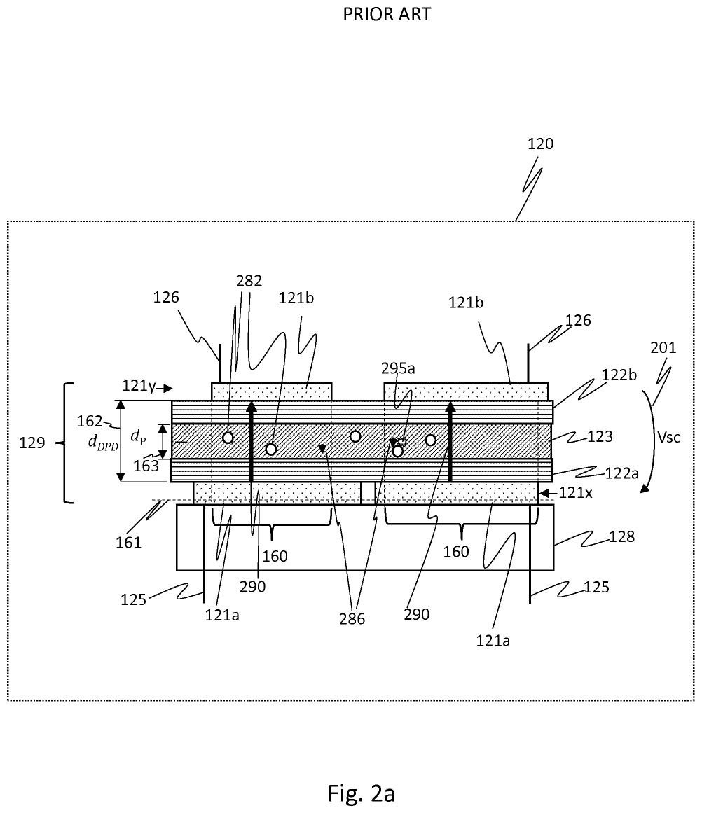

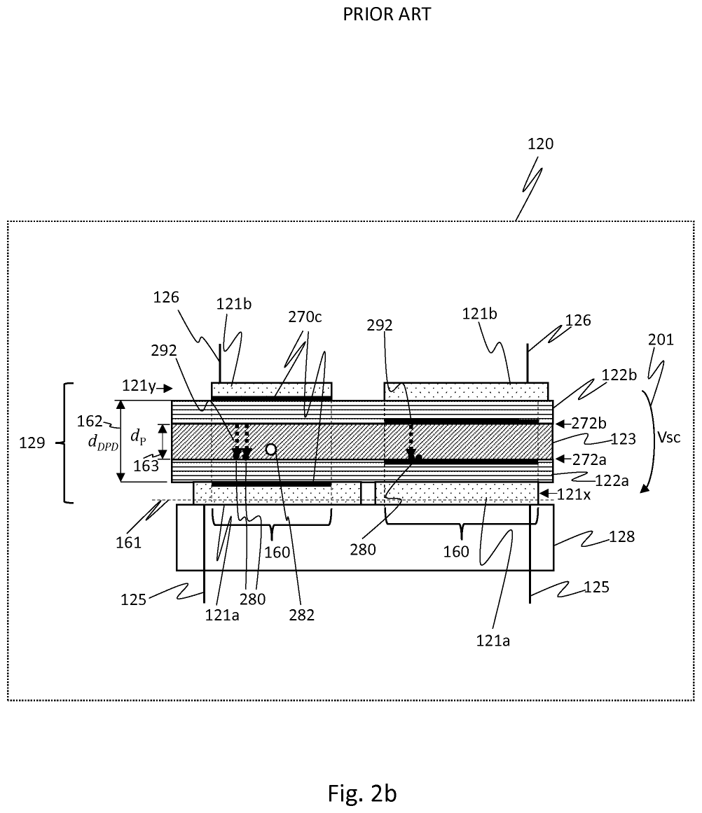

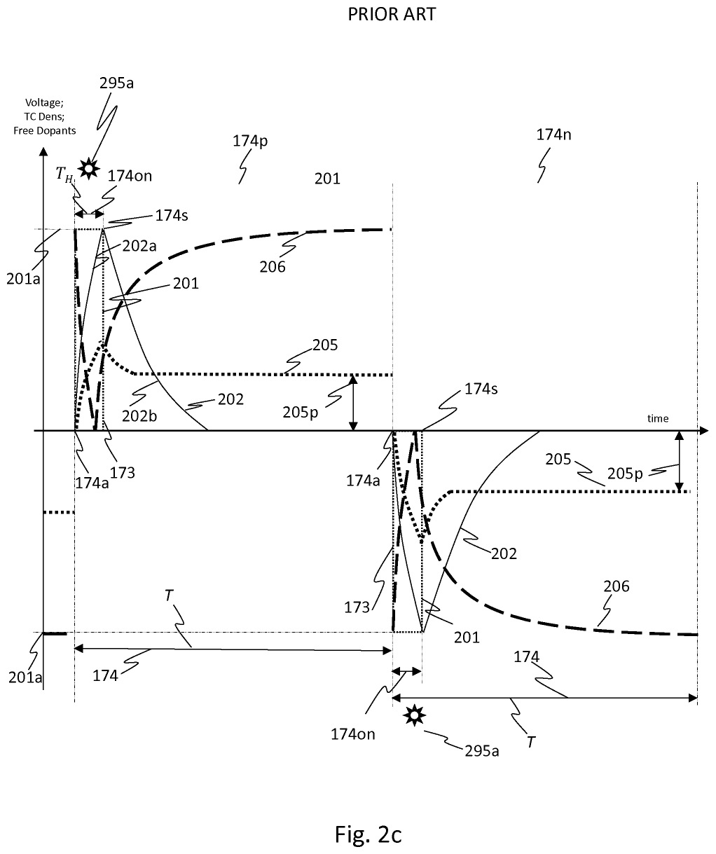

FIG. 2a shows a schematic side view and cut-out view of a TFEL display panel 120 in more detail, in particular the details important to light production from the thin film layer structure 129 of the TFEL display panel 120 on a substrate 128. Dimensions of the TFEL display panel 120 and its units are exaggerated as the thin film layer structure 129 is really orders of magnitude thinner than the substrate 128, or the width dimension of the structure. This naturally holds also for the atom-scale particles marked with 282 and 286 in FIG. 2a that are discussed more later in the description.

As illustrated and discussed already above, the light emission or production region of the TFEL display panel 120 is the phosphor layer 123 comprising a transparent and doped semiconducting material, e.g. zinc sulfide (ZnS) doped with manganese (Mn) or terbium (Tb) atoms. Thickness of the phosphor layer 163 (d_{P}) is typically in the order of some 100s of nanometers (e.g. 500 nm). Preferable deposition and doping method of the fabrication of the phosphor layer is the atomic layer deposition method in the manufacture of the display.

The phosphor layer 123 is arranged to be surrounded with two electrically highly insulating layers, first insulating layer 122a (or a first dielectric layer 122a) and second insulating layer 122b (or a second dielectric layer 122b). Preferable material of the insulating layers a so-called nanolaminate of titanium oxide and aluminium oxide layers, again preferably deposited with the atomic layer deposition method. Thickness of the first insulating layer 122a is again some hundreds of nanometers (e.g. 200 nm-300 nm) and the thickness of the second insulating layer 122b is also some hundreds of nanometers (e.g. 200 nm-300 nm).

Around the stack of the two insulating layers 122a, 122b and the phosphor layer 123, a first electrode layer 121x and second electrode layer 121y are arranged. First electrode layer comprises one or more common electrodes 121a. Second electrode layer comprises one or more segment electrodes 121b. Areas of light production are determined by the lateral overlap or overlapping area 160 along a base plane 161 of a segment electrode 121b and a common electrode 121a. This is because the light production is based on the excitation and movement of so-called hot electrons 286 between the segment electrodes and common electrodes. In their travel, the hot electrons may collide with dopant atoms 282 of the phosphor layer 123. These collisions excite the dopant atoms 282 (their orbital electrons move to higher orbitals from their ground state) but only if the kinetic energy of the electrons 286 is high enough. When the excitation state of the dopant atom 282 is released at least partially, and the orbital electrons of the dopant atoms 282 move back to or towards the ground state, a photon is emitted with a wavelength determined by the energy level change of the orbital electron. One such emission is marked with label 295a. With proper dopants 282, emission wavelengths are at least in part in spectrum of the visible wavelengths, that is, it is perceived as light by the human sense of vision or sense of sight. Usually the emission has also a dominant colour depending on the dopant, as discussed above already. Above and throughout the present application, the base plane 161 means a fictitious plane which defines a lateral extension of the TFEL display panel 120. Driving voltage signals 201 are fed to the electrodes 121a and 121b with common electrode connections 125 and segment electrode connections 126, respectively.

Hot electrons 286 are generated by arranging an electric field 290 between the segment and common electrodes. The electric field is created by arranging a driving voltage signal 201 (V_{SC}) from a segment electrode 121b to a common electrode 121a (in FIG. 2, the voltage V_{SC} has a negative polarity as electric field lines 290 start from a common electrode 121a to a segment electrode 121b). Thus, in the illustration of FIG. 2a, common electrodes 121a have a positive voltage in relation to the segment electrodes 121b.

It is to be appreciated that with a typical driving signal or driving voltage pulse amplitude of e.g. 200V and with a typical separation 162 (d_{DPD}) between segment electrode and a common electrode (determined by the aggregate thickness of each of the first insulating layer 122a—phosphor layer 123—second insulating layer 122b) of e.g. 1000 nm, an electric field of the magnitude of 200V/1000 nm=0.2 GV/m is created. Such a high field is able to “drag” electrons e.g. from the conductor areas of segment and common electrodes to become said hot electrons. As electrons carry a negative charge, hot electrons 286 are moving due to the electric field 290, in the context of FIG. 2a, from up to down.

With an alternate polarity of the driving voltage signal 201, all the directions in FIG. 2a are naturally reversed. Continuous light production of a TFEL display requires that the voltage between the segment electrodes 121b and common electrodes 121a is arranged as driving pulses of alternating polarity. FIG. 2a can be considered to show the light production during one driving pulse with a positive polarity from common electrodes 121a to segment electrodes 121b. After a driving pulse, a next driving pulse having an alternate polarity (related to FIG. 2a, a positive polarity from segment electrode 121b to common electrode 121a) is to be arranged to the common and segment electrodes for light production. This process is repeated as long as light is to be produced from the overlapping area 160 of a segment electrode and a common electrode.

In the driving of the electrodes, driving frequency of the pulses is typically 100 Hz-5000 Hz. As a rule of thumb, the higher the pulse frequency, the brighter the light output is. If the frequency drops below 50 Hz, the display may be perceived to flicker as the sense of vision can start to detect the change in the light output.

The amplitude of the driving voltage pulse is also important as the light generation of a TFEL display is a quantum mechanical phenomenon, and the excitation and the release of the dopant atoms 282 involves a certain threshold energy. In the thin film structure 129, this translates to a high enough electric field accelerating the hot electrons 286, which, in turn, directly translates to the required voltage amplitude of the driving voltage pulse, and to the separation of a segment electrode 121b and a common electrode 121a.

Referring next to FIG. 2b, during the driving pulse with the polarity of positive common electrodes 121a, some hot electrons 286 accumulate to the interface and into the vicinity of the interface 272a between the dielectric layer 122a and the phosphor layer 123 and become trapped electrons 280. Trapped electrons 280 form a sheet of charges with a surface charge density σ_{T} at the interface 272a and create a trapped electron electric field 292 parallel to the electric field 290 caused by the driving voltage V_{SC} (V_{SC} having in FIG. 2b a positive polarity at the common electrodes 121a) but opposite in direction. With an alternate polarity of the driving signal pulse, the trapped electrons 280 would naturally be trapped to the interface and into the vicinity of the interface 272b. Trapped electrons 280 may also form a thin volume of charges with a volume charge density ow at the interface and in the vicinity of the interface and create a trapped electron electric field 292 parallel to the electric field 290 caused by the driving voltage V_{SC}, but opposite in direction. Trapped electron electric field 292 gives rise to a voltage, in the present application called later an “inner capacitor voltage”, 271v. This is one of the reasons the driving pulses must alternate in polarity. In other words, the TFEL display presented in the current application is an AC (alternating current) TFEL display in contrast to the DC driven TFEL display, of which an organic LED (OLED) based display is a typical example.

An overlapping area 160 of a segment electrode 121b and a common electrode 121a forms a plate capacitor, called also a “display electrode capacitor” 270c, defined in size and shape by the overlapping area 160 of the segment electrode 121b and a common electrode 121a. In a side cut-out view, overlap in only one dimension is shown, but naturally in a real physical display, the overlap comprises a two-dimensional shape or area 160, usually in a shape of a picture element, e.g. warning sign of an overheating motor, or an arrow pointing a direction. Owing to the thin (e.g. 1000 nm-2000 nm) and uniform nature of the thin film structure between the display electrode capacitor segment and common electrodes, determined by the first dielectric layer 122a, phosphor layer 123 and second dielectric layer 122b, the relationship of the voltage V, separation 162 of the segment electrodes and the common electrode d_{DPD} (dielectric-phosphor-dielectric) in the display electrode capacitor and electric field strength E is with good accuracy a well-known relation: E=V/d_{DPD}. Thus, theoretically it is possible to make a stronger field for hot electron 286 generation and movement by increasing the voltage V or by decreasing the separation d_{DPD} of the plates, that is, by making the phosphor layer 123 and dielectric layers 122a, 122b thinner. However, there is a limit to how much the structure can be made thinner. With a too thin phosphor layer 123, amount of dopants 282 available for light emission decreases, having a negative effect on the light generation. Further, with too thin dielectric layers 122a, 122b, the risk of an electrical breakdown (arching leading to a short circuit) increases. Other elements in FIG. 2b correspond to those in FIG. 2a.

FIG. 2c shows a typical driving voltage pulse sequence of a prior art TFEL display. Driver electronics unit 140 (shown in FIG. 1) is arranged to generate a driving voltage signal 201 comprising driving voltage pulses 173, shown with a dotted line 201 of alternating polarity with a positive driving pulse period 174p and negative driving pulse period 174n. These alternated pulses are then repeated for the duration of light generation. Driving pulse period 174 is a length in time, and its inverse is the driving frequency f. The driving pulse period 174 (also marked as time T; f=1/T) can be adjusted before the operation of the display or during the operation of the display e.g. based on desired brightness of the display. Naturally, a positive driving pulse period 174p and a negative driving pulse period 174n can have a same or a different length in time. Driving voltage pulse 173 and driving pulse period 174 both start at time 174a, at a point of time where the driving voltage signal 201 is initially at zero, but immediately thereafter raises to an amplitude voltage 201a. This amplitude voltage 201a may be a steady DC level, or a DC level with a ripple voltage component e.g. due to nonideal rectification. The voltage pulse is held for time 174on (marked also as T_{H}) at the amplitude voltage 201a, and then at time 174s, the driving voltage signal 201 is cut off back to zero level which it reaches a bit later. Thus, time 174on is the time the driving voltage pulse 173 is kept at the amplitude voltage 201a outside its rising and falling edges.

When a display electrode capacitor is fed with a voltage pulse through a pair of conductors with a non-infinite conductivity, the charging of the plate capacitor of the segment-common electrode combination does not happen instantaneously but instead exhibits a typical capacitor charging behaviour (time constant RC) in the voltage 202 of the segment-common electrode combination. The charging voltage has a slope 202a towards the amplitude voltage 201a and then a slope 202b from the charging voltage towards a zero potential when the display electrode capacitor 270c of FIG. 2b is e.g. short circuited. Said short circuiting happens between common electrode driving node 125a and the segment electrode driving node 126a, through a pair of conductors with a finite conductivity between a common electrode 121a and the common electrode driving node 125a, and a segment electrode 121b and a segment electrode driving node 126a.

The trapped electron density at the dielectric layer-phosphor layer interface and at the vicinity of the interface is shown with curve 205. As the trapped electrons are a result of the hot electrons trapped to the said interface, their density increases as long as voltage over the display electrode capacitor is high enough to cause hot electron movement. When the voltage of the driving voltage signal 201 is set back to zero, the accumulation of the trapped electrons stops and starts to decline a bit, but then plateaus to a level 205p. This is believed to be because the trapped electrons in the sheet or thin volume of electrons at the interfaces 272a and 272b (shown in FIG. 2b) repulse each other, and when a certain amount electrons are pushed away from the sheet of electrons, an equilibrium of the trapping force of the interface and a repulsive force is reached and the trapped electron density remains, in the absence of any further excitation, the same for the duration of the rest of the driving pulse period 174. The trapped electron density generates a trapped electron related electric field 292 opposing the electric field 290 (shown in FIG. 2b) generated by the driving voltage pulse 173. As the trapped electrons reside on the interface of the phosphor layer 123 and dielectric layer 122a or 122b (and not at the interface of the dielectric layer 122a and common electrode 121a, or at the dielectric layer 122b and the segment electrode 121b) setting the display electrode capacitor voltage to zero does not remove or cancel the trapped electrons 280 from the said interface or from the vicinity of the said interface. This explains why the plateau 205p does not collapse to zero when the driving voltage signal 201 is brought to zero at a common electrode driving node 125a and a segment electrode driving node 126a of the driver electronics unit 140 connected to said electrodes. Trapped electron density 205 is shown negative for the driving pulse period 174n to highlight the change in polarity (interface 272a vs. interface 272b).

Finally, the curve 206 in FIG. 2c shows the density of the free dopants or free dopant atoms for light production at any one time. When a hot electron has collided with a dopant atom 282, the dopant atom may enter an excited state. Only when this excited state is released completely or to a lower energy state, light (a photon) is emitted. After the excitation-release cycle, the dopant atom 282 becomes again free to participate in the light emission. Thus, when a voltage 202, generated by a driving voltage signal 201 generated in the driver electronics unit 140 is applied from a segment electrode 121b to the common electrode 121a in a positive or negative polarity, the free dopant atom density decreases very rapidly from the initial peak value towards zero. However, even before the voltage 201 of the display electrode capacitor is turned back to zero during one driving pulse period 174, the free dopant density 206 starts to increase again. This is because the repulsive force of the trapped electrons 280 and the opposing trapped electron electric field 292 generated by the trapped electrons 280 makes light generation less likely, and finally impossible. In the absence of hot electrons 286 capable light production, that is, of high enough kinetic energy, dopant atoms 282 no longer can participate in light emission and therefore remain free for light emission. Shortly after the beginning of the driving pulse period 174, the hot electrons 286 have no longer the capacity for excitation due to the opposing trapped electron electric field 292 of the hot electrons 286 that have become trapped electrons 280 in the first dielectric layer-phosphor layer interface 272a or in the second dielectric layer-phosphor layer interface 272b, depending on the polarity of the driving voltage pulse 173 (above, elements 272a, 272b, 280, 282, 286 and 292 are shown in FIG. 2b). Free dopant density 206 is drawn negative for the pulse period 174n for clarity, to match the voltage related curves below the time axis.

Thus, in summary, the prior art light production of an AC TFEL is a result of two factors:
1. Hot electrons 286 traversing through the first dielectric layer 122a, the phosphor layer 123 and the second dielectric layer 122b stack (or through the second dielectric layer 122b, the phosphor layer 123 and the first dielectric layer 122a stack) and having a high enough energy for excitation of dopant atoms 282 in the phosphor layer 123. This excitation leads then to the release of the excitation, said release resulting in a primary light emission 295a, and
2. The availability of the dopant atoms 282 in the phosphor layer 123 in a state ready for the excitation, e.g. in a ground state.

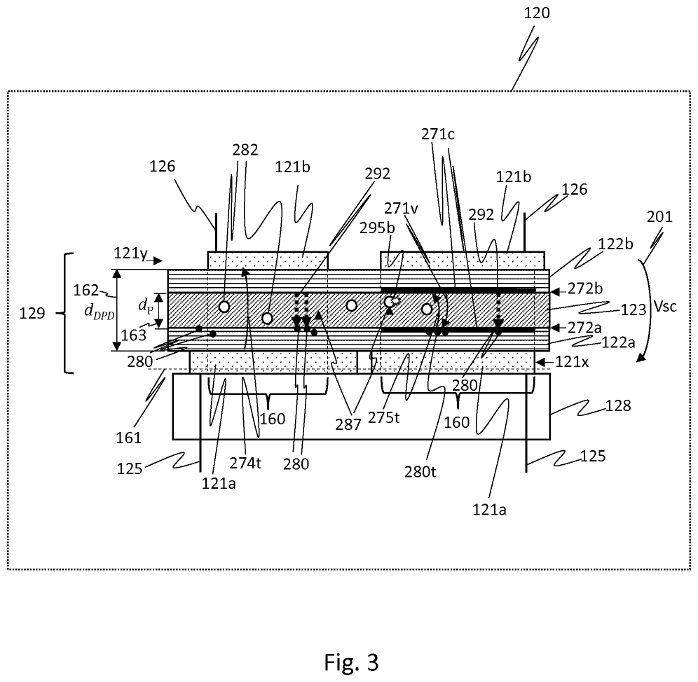

Referring now to FIG. 3, it has been surprisingly found that in the practical driving of an AC TFEL display, the trapped electrons 280 in and in the vicinity of the dielectric layer-phosphor-layer interface can be accumulated to a surface density σ_{T} or a volume density σ_{TV} that generates a high-enough trapped electron electric field 292 over the phosphor layer 123 for a secondary light production during a driving pulse period 174. This light pulse can be seen or measured as a so-called “secondary light emission” or a “discharge light emission” 295b during one driving pulse period. With this naming convention, the prior art light production is based on a light pulse called “a primary light emission” (shown as 295a in FIG. 2a), or a “charging light emission”.

Shown in FIG. 3 in detail, the phosphor layer 123, the overlapping area 160 along the base plane 161 of a segment electrode 121b and a common electrode 121a, the first dielectric layer-phosphor layer interface 272a and the second dielectric layer-phosphor layer interface 272b define a so-called inner capacitor 271c. The trapped electrons 280 reside in the interface and in the vicinity of the first dielectric layer-phosphor layer interface 272a or the second dielectric layer-phosphor layer interface 272b, depending on the driving voltage signal polarity. In the inner capacitor 271c, the fictitious capacitor plates are the area of the overlap 160 of the interfaces 272a, 272b, and the separation of the fictitious plates is determined by the phosphor layer 123 thickness d_{P}, marked with 163.

The secondary light emission occurs in the inner capacitor when the driving voltage signal 201 from the driver electronics unit 140 fed to the segment electrode 121b and common electrode 121a is set to zero in the falling edge of the driving pulse, which may be equivalent to short circuiting a segment electrode driving node 126a and a common electrode driving node 125a of the driver electronics unit 140. After the driving voltage signal 201 is set to zero, the electric field 290 due to the driving voltage pulse 173 of the driving voltage signal 201 between the segment electrode and common electrode (that is, inside the display electrode capacitor) rapidly collapses. Thus, the electric field 290 is no longer able to keep the trapped electrons 280 in the dielectric layer-phosphor-layer interface, and the trapped electrons can move over the phosphor layer 123 due to their mutual repulsion. Therefore, they become again hot electrons 287 capable of light production by hitting dopant atoms 282 with a high-enough kinetic energy leading to light emission, indicated with an emission symbol 295b.

It is surprising that the secondary light emission can be achieved with no further excitation or usage of power by the driver electronics unit 140 if the charge due to the trapped electrons 280 in the inner capacitor 271c exceeds a threshold charging 280t. Even when the AC TFEL displays have existed since the late 1980s, said secondary light emission has not been observed. This is likely because the main AC TFEL display type has been a passive matrix type of display where it is advantageous to keep the driving pulses very short. With matrix displays, the entire set of rows of the matrix display has to be driven or “sweeped” with separate driving pulses for every row to arrange a separation of pixel between any two adjacent rows, and to avoid flickering, one sweep of display rows can take maximally approximately 1/25 s. In commercial TFEL matrix displays, there are can be over 400 rows, setting the maximum driving pulse period to 1 s/(25×400)=100 μs (micro seconds) in that type of a display. In practice, the driving pulse period 174 is e.g. 55 μs for a commercial passive matrix TFEL display, mostly determined by the non-zero charging time of the row electrodes. Also, as can be seen in FIG. 2c, there appears to be no benefit in keeping the driving voltage signal in the amplitude status for a long time (this time is indicated with time span 174on) as the light emission from the primary pulse happens quickly after the driving voltage pulse 173 is launched to a display electrode capacitor, manifested e.g. with the behaviour of curve 206, the density of the free dopant atoms.

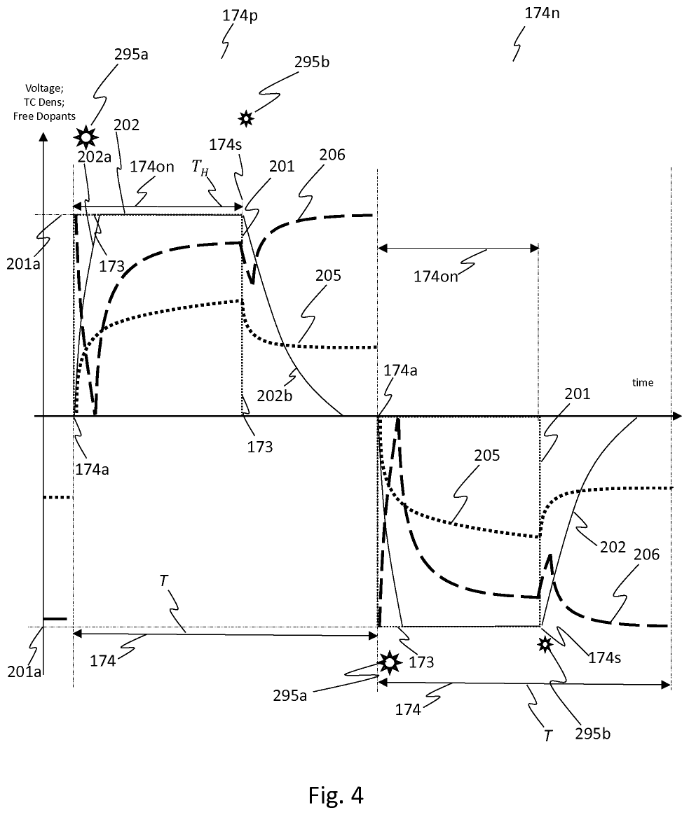

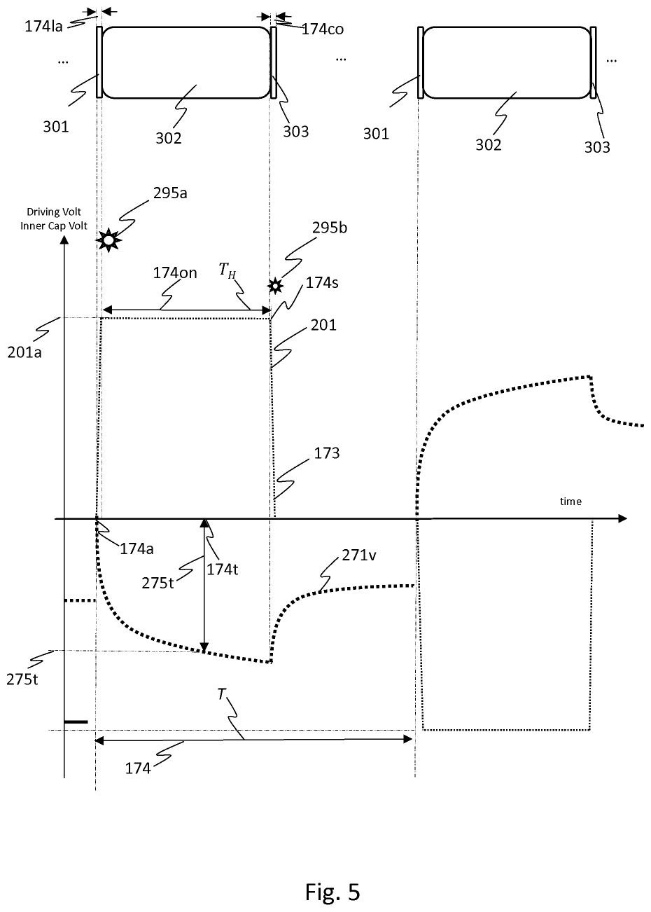

Thus, referring to FIGS. 3-5, according to an aspect of the present invention, a method for driving a TFEL display is disclosed. FIG. 3 shows the structure of the TFEL display and especially the inner capacitor 271c as discussed above, important for understanding the present invention. FIG. 4 shows the timing of the driving pulse and the related voltages, trapped electron densities and free dopant densities according to an aspect of the invention. FIG. 5 highlights the method steps according to an aspect of the present invention.

FIG. 4 resembles prior art FIG. 2b, with the important distinction of a considerably longer driving voltage pulse 173 on state 174on (time T_{H}). As can be seen, due to the longer on-state, two important differences arise in FIG. 4 vis-à-vis FIG. 2c: The trapped electron density 205 at the dielectric layer-phosphor layer interface, in the inner capacitor 271c, is at a considerably higher level in FIG. 4 than in FIG. 2c at the time of 174s (the end of the so-called holding step in the method according to an aspect of the invention). Also the level of the free dopant density 206 is higher at the time of 174s which is the time the driving voltage signal 201 starts the falling edge of the driving voltage pulse 173 towards zero level from the amplitude voltage level 201a.

Thus, the release of the trapped electrons due to the cut-off of the driving voltage signal 201 keeping the charges trapped is capable of light emission as the cut-off step is started after the charge of the inner capacitor exceeds the threshold charging 280t, and thus a secondary light emission 295b from the inner capacitor 271c is generated.

In an embodiment, the release of the trapped electrons due to the cut-off of voltage 201 keeping the charges trapped is capable of light emission as the cut-off step is started after the voltage of the inner capacitor exceeds the inner threshold voltage 275t, and thus a secondary light emission 295b from the inner capacitor 271c is generated.

FIG. 5 highlights the method steps in relation to the charging of the inner capacitor. As can be seen, the method for driving comprises three distinct steps in the following order a)-c): The method comprises first a) launching step 301 where the driving voltage signal 201 is brought to the amplitude voltage level 201a to launch the driving voltage pulse 173, as the rising edge of the driving voltage pulse 173. The method comprises also step b), a holding step, 302 where the driving voltage signal is held in a DC (direct current) voltage as the on-state of the pulse. The driving voltage signal 201 may, in addition to DC component, also comprise a ripple voltage component, ripple voltage being e.g. a residual periodic variation of the DC voltage within a power supply which has been derived e.g. from an alternating current (AC) source. Finally, as the third or c) step, the method comprises a cut-off step 303, where the driving voltage signal 201 is brought from the amplitude voltage 201a back to a zero level in the falling edge of the driving voltage pulse 173.

In other words, referring to FIGS. 1 and 3-5, in an aspect of the present invention, a method for driving a thin film electroluminescent display 100 is disclosed. As the aspect is related to a method driving a TFEL display 100, the elements of the prior art TFEL display 100 in FIG. 1 are valid, with the exception of the inherent generation of the inventive driving voltage signal 201 and the related method steps for generating the driving voltage signal 201. The TFEL display 100 comprises a TFEL display panel 120 comprising a typical thin film stack of an AC driven TFEL display, that is, a stack of a first electrode layer 121x comprising a common electrode 121a. There can naturally be one or more common electrodes 121a arranged to the first electrode layer 121x e.g. by first sputtering a layer of conductive transparent oxide, e.g. indium doped tin oxide (“ITO”) on a substrate, and the patterning it through well-known lithographical techniques. The stack comprises, on the first electrode layer 121x, a first dielectric layer 122a of a good electric insulator, e.g. a nanolaminate of aluminium oxide and tin oxide deposited e.g. with the well-known atomic layer deposition method. The stack comprises also, on the first dielectric layer 122a, a phosphor layer 123 which comprises the dopant atoms e.g. ZnS (zinc sulfide) doped with Mn (manganese) or Tb (terbium), phosphor layer 123 deposited e.g. with ALD. The stack also comprises a second dielectric layer 122b on the phosphor layer 123 (arranged as the first dielectric layer 122a, e.g. with ALD), and a second electrode layer 121y (arranged as the first electrode layer e.g. with sputtering and lithography) on the second dielectric layer 122b, second electrode layer 121y comprising a segment electrode 121b, or one or more segment electrodes 121b.

The common electrode 121a and the segment electrode 121b are at least partially overlapping in an overlapping area 160 along a base plane 161. In the present application, the base plane 161 means a fictitious plane which defines a lateral extension of the TFEL display panel 120. The base plane 161 may be planar in the direction of the substrate 128, e.g. a thin soda lime glass sheet. The base plane 161 may also be slightly curved e.g. if the glass sheet is laminated in a curved windshield. As explained above, light emission occurs in a volume defined by the boundary of the overlapping area 160 of the common and segment electrodes and the thin film structure (first and second dielectric layers 122a and 122b, respectively, and a phosphor layer 123) between the common and segment electrodes. This is because the overlapping area is the area where the hot electrons are created and capable of hitting the dopant atoms of the phosphor layer 123. Stated differently, the overlapping area 160 is the projection of the segment electrode 121b to the common electrode 121a, and the area which is common to both the segment electrode 121b and the common electrode 121a is the overlapping area 160.

The TFEL display 100 comprises a driver electronics unit 140 comprising a common electrode driving node 125a and a segment electrode driving node 126a. The driving voltage signal 201 is generated in the driver electronics unit 140 to the common electrode driving node 125a and the segment electrode driving node 126a as a voltage difference between nodes 125a and 126a. From these nodes 125a and 126a, the voltage is connected to the segment electrodes 121b and common electrodes 121a through segment electrode connections 126 and common electrode connections 125, respectively. Driver electronics unit 140 is reviewed and explained in detail in relation to FIG. 1.

The TFEL display panel 120 comprises also a display electrode capacitor 270c. The display electrode capacitor 270c comprises the overlapping area 160 of the segment electrode 121b and the common electrode 121a, which correspond to the regions of the segment electrode 121b and common electrode 121a inside the overlapping area, bounded by the overlapping area 160. The display electrode capacitor 270c comprises also part of the first dielectric layer 122a bounded by the overlapping area 160, part of the phosphor layer 123 bounded by the overlapping area 160, and part of the second dielectric layer 122b bounded by the overlapping area 160. Thus, only the areas of the layers 122a, 122b and 123 that are bounded (that is, have the same border and location) as the overlapping area 160 are part of the display electrode capacitor 270c.

The display electrode capacitor 270c comprises also an electrode threshold voltage 274t required for primary light emission 295a. The electrode threshold voltage 274t may be e.g. 120V-160V, more preferably 130V-150V or most preferably 135V-145V, depending on the physical structure of the TFEL display panel 120, especially depending on the thicknesses of the thin films. Below the electrode threshold voltage, there is no primary light emission as the hot electrons cannot have enough energy for dopant atom excitation that would generate light when hot electrons travel from segment electrode 121b to common electrode 121a, or wise versa.

The TFEL display panel 120 comprises also a first dielectric layer-phosphor layer interface 272a between the first dielectric layer 122a and the phosphor layer 123, and a second dielectric layer-phosphor layer interface 272b between the second dielectric layer 122b and the phosphor layer 123. The first dielectric layer-phosphor layer interface 272a is a thin sheet-like volume or layer where the trapped electrons 280 accumulate during a driving voltage pulse 173, during one polarity of the driving voltage signal 201. Similarly, the second dielectric layer-phosphor layer interface 272b is a thin sheet-like volume or layer where the trapped electrons 280 accumulate during another polarity of the driving voltage pulse 173 of the driving voltage signal 201. The first dielectric layer-phosphor layer interface 272a and the second dielectric layer-phosphor layer interface 272b form the fictitious “capacitor plates” of the inner capacitor 271c, as bounded by the overlapping area 160.

Thus, the TFEL display panel 120 comprises also an inner capacitor 271c. As already indicated, the inner capacitor 271c comprises part of the first dielectric layer-phosphor layer interface 272a bounded by the overlapping area 160, part of the phosphor layer 123 bounded by the overlapping area 160, and part of the second dielectric layer-phosphor layer interface 272b bounded by the overlapping area 160. The inner capacitor 271c is a capacitor which is charged by the trapped electrons 280 and which accumulates the energy needed for secondary light emission 295b. The “capacitor plates” of the inner capacitor 271c are bounded by the same overlapping area 160 that defines the boundaries of the display electrode capacitor 270c. Of course, in case of more than one segment electrodes or more than one common electrodes defining many overlapping areas and many display picture elements like segments or pixels, there are many display electrode capacitors 270c and many inner capacitors 271c.

Still referring to FIGS. 3-5, the TFEL display 100 comprises a common electrode connection 125 arranged to electrically connect the common electrode 121a with the common electrode driving node 125a, and a segment electrode connection 126 arranged to electrically connect the segment electrode 121b with the segment electrode driving node 126a. In practice, the electrode connections 125 and 126 may be e.g. a series connection of a PCB trace connecting the driving circuitry of the driver electronics unit 140 to a pad area, pad area for the FPC (flexible printed circuit), then the FPC, pad area of the display panel 120 to which the other end of the FPC is bonded, and then the traces of e.g. transparent conductive oxide traces in the first and second electrode layers 121x and 121y, respectively, leading finally to the common and segment electrodes 121a and 121b, respectively.

In terms of the method steps, the method comprises generating, in the driver electronics unit 140 a driving voltage signal 201 between the common electrode driving node 125a and the segment electrode driving node 126a. As discussed above, from the driving nodes, the driving voltage signal is distributed to the segment and common electrodes. Referring to FIG. 5, the driving voltage signal 201 comprises driving voltage pulses 173. Each of the driving voltage pulses has a driving pulse period 174 and an amplitude voltage 201a, which is the maximum value of the driving voltage pulse 173. The method comprises, in the following order, during the driving pulse period 174, the steps of:
a) launching, in a launching step 301 lasting a launching time 174la, the driving voltage signal 201 from a zero voltage to the amplitude voltage 201a for launching the driving voltage pulse 173 and for commencing a charging of the inner capacitor 271c,
b) immediately after the launching step 301, holding, in a holding step 302 lasting an on-time 174on, the driving voltage signal 201 between the common electrode driving node 125a and the segment electrode driving node 126a in the amplitude voltage 201a for continuing the charging of the inner capacitor 271c, and
c) immediately after the holding step 302, cutting, in a cut-off step 303 lasting a cut-off time 174co, the driving voltage signal 201 to a zero voltage, the cut-off step 303 starting after the inner capacitor 271c has been charged to a threshold charging 280t capable of generating a secondary light emission 295b from the inner capacitor 271c.

Thus, the launching step 301 corresponds the rising edge of the driving voltage pulse 173, the holding step 302 corresponds to the on-time at the amplitude voltage 201a of the driving voltage pulse 173, and the cut-off step 303 corresponds to the falling edge of the driving voltage pulse 173. According to an aspect of the invention, the cut-off step 303 takes place when the inner capacitor 271c has been charged to a threshold charging 280t capable of generating a secondary light emission 295b from the inner capacitor 271c. The cut-off step 303 may start immediately after the inner capacitor 271c has been charged to a threshold charging 280t capable of generating a secondary light emission 295b. Alternatively, the cut-off step 303 may start only after some time has passed since the inner capacitor 271c has been charged to a threshold charging 280t capable of generating a secondary light emission 295b. However, the launching step 301, the holding step 302 and the cut-off step 303 must occur during one driving pulse period 174 (and then get repeated during next driving pulse periods 174). As shown in FIGS. 4-6, launching step 301 starts at the beginning of a driving pulse period 174, at a moment in the period marked with 174a.

As shown in FIGS. 4 and 5, the polarities of the successive pulses 173 alternate. In other words, two successive driving pulses 173 during two successive driving pulse periods 174 have alternating polarities. Thus, the concept of a falling edge and rising edge, and the amplitude value of a pulse is to be understood relative to the absolute value of the voltage of the driving voltage signal, and relative to the zero voltage.

In an embodiment, in the method for driving a TFEL display 100, the inner capacitor 271c comprises an inner threshold voltage 275t required for light emission, and the cut-off step 303 starts after an inner capacitor voltage 271v of the inner capacitor exceeds the inner threshold voltage 275t capable of generating a secondary light emission 295b from the inner capacitor 271c. The moment the inner capacitor voltage 271v of the inner capacitor exceeds the inner threshold voltage 275t is marked with 174t in FIG. 5. The cut-off step 303 starts after this moment 174t, at time 174s. This is a way of stating a condition for the secondary light emission to emerge. The trapped electrons 280 in the first dielectric layer-phosphor layer interface 272a and second dielectric layer-phosphor layer interface 272b give rise to a trapped electron electric field 292 substantially perpendicular to the phosphor layer 123 and across the phosphor layer 123. Thus, the exists an inner capacitor voltage 271v which is a line integral of the trapped electron electric field 292 generated by the trapped electrons 280, said trapped electron electric field 292 directed over the phosphor layer 123. If the inner capacitor voltage 271v exceeds the inner threshold voltage 275t at the start of the cut-off step 303, a secondary light emission 295b occurs (voltage levels in the driving voltage signal 201 and inner capacitor voltage 271v are not in scale in terms of voltage in FIG. 5).

In an embodiment, in the method for driving a TFEL display 100, the duration of the launching time 174la is 1 μs-10 μs, and the amplitude voltage 201a of the driving voltage pulse 173 is equal or more than the electrode threshold voltage 274t. A rapid launching time and the fact that amplitude voltage 201a is over the threshold voltage implies that a bright primary emission is desired. The electrode threshold voltage 274t may be e.g. 120V-160V, more preferably 130-150V or most preferably 135-145V. The amplitude voltage 201a of the driving voltage pulse 173 may be e.g. 185V-210V, more preferably 190V-205V or most preferably 195V-200V.

For a so-called low-voltage TFEL structures, the amplitude voltage 201a of the driving voltage pulse 173 may be also e.g. 65V-95V, more preferably 70V-90V or most preferably 75V-85V. Similarly, the threshold voltage of a low-voltage TFEL structure may be 45V-65V, more preferably 48V-60V and most preferably 50V-55V.

In an embodiment, in the method for driving a TFEL display 100, the duration of the on-time 174on is 250 μs (micro-seconds)-40 ms (milli seconds), more preferably 1 ms-20 ms, or most preferably 2 ms-10 ms. These are clearly (even at 250 μs lower, minimum limit) almost order-of magnitude longer on-times 174on than previously used in the prior art AC TFEL displays, well capable of generating the secondary light emission, too.

In terms of the duration of the pulse period 174, the pulse period 174 length or duration may be 1%-500% longer than a combined duration of the on-time 174on and launching time 174la. More preferably the pulse period 174 length is 10%-50% longer than a combined duration of the on-time 174on and launching time 174la. Most preferably the pulse period 174 length is 20%-30% longer than a combined duration of the on-time 174on and launching time 174la.

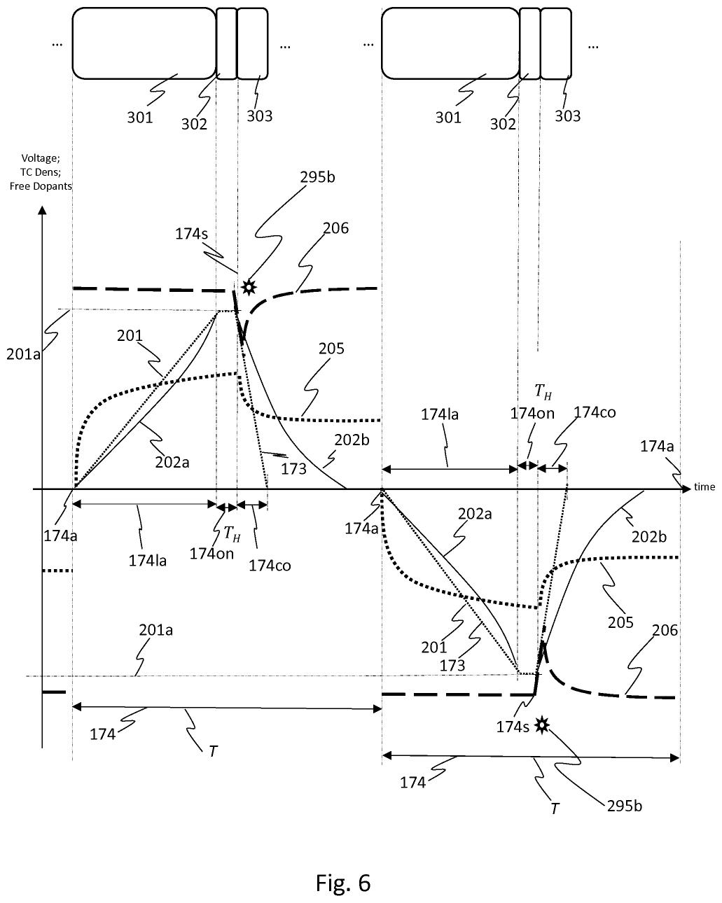

FIG. 6 shows, in an embodiment, a driving voltage pulse 173 that has almost a triangular shape, with a relatively long launching step 301, a relatively brief holding step 302 and a relatively brief cut-off step 303. Due to the long launching step 301, there is no primary light emission 295a as the hot electrons 286 do not have the energy to excite dopants atoms for light emission as the trapped electron electric field 292 cuts the energy of the hot electrons and blocks the primary light emission 295a. Thus, the level of the free dopant density 206 remains high until time 174s when the cut-off step 303 starts. However, the secondary light emission 295b does emerge at time 174s, at the start of the cut-off step 303. The trapped electron density 205 also increases during the launching step 301 and during holding step 302 the as the inner capacitor is charged until the start of the cut-off step 303. Thus, the inner capacitor is capable of light emission or light output with the charge charged therein. It is obvious that with just secondary light emission, the level and brightness of light output is considerably lower than with primary light emission. Therefore, the invention of the present application allows for a very broad range of brightness control.

In all embodiments of the invention, the time behaviour of the launching step voltage may be linear. In other words, the driving voltage signal 201 raises in magnitude along a straight line from zero voltage at the start of each of the driving pulsed periods 174 to the amplitude voltage value 201a during the launching time 174la.

In all embodiments of the invention, the time behaviour of the launching step voltage may be monotonously increasing and piece wise linear. In other words, the driving voltage signal 201 raises in magnitude along segments of interconnected straight lines from zero voltage at the start of each of the driving pulsed periods 174 to the amplitude voltage value 201a during the launching time 174la, but the aggregate line of the segment lines is not a straight line but comprises one or more corners.

Advantageous values for the said “long” launching step are various. In an embodiment, the launching time 174la may be e.g. 1 ms-20 ms, more preferably the launching time 174la may be 2 ms-10 ms, or most preferably the launching time 174la may be 4 ms-8 ms.

In an embodiment, the duration of the launching time 174la is long enough to suppress the primary light emission 295a from occurring. In this embodiment, the light emission is arranged only by the secondary light emission 295b during one driving pulse period 174as explained in relation to FIG. 6. It has been also surprisingly found that a slowly (relative to normal time constants of pulses encountered in the driving of TFEL displays) increasing the driving voltage signal 201 of the driving voltage pulse 173 (indicated by a long launching time 174la) and then rapidly cutting off the driving voltage (indicated by a short cut-off time 174co) suppresses the primary light emission 295a entirely. The time behaviour of the launching step voltage may be linear or piece wise linear.

In an embodiment, it is also possible to set the duration of the launching time 174la so that the peak luminance of the primary light emission 295a is less than the peak luminance of the secondary emission 295b during the driving pulse period 174, but the primary light emission 295a still occurs. Making a setting for the duration of the launching time 174la vs. luminance of the primary and secondary light emission 295a and 295b is readily done e.g. with a spectrophotometer. The time behaviour of the launching step voltage may be linear or piece wise linear.

To formulate an advantageous on-time length in the dim end of the brightness scale, it is advantageous to state the following relative lengths for the on-time 174on length. Thus, in an embodiment, the duration of the on-time 174on may be 1%-20% of the launching time 174la, more preferably the duration of the on-time 174on may be 2%-10% of the launching time 174la, or most preferably the duration of the on-time 174on may be 5%-8% of the launching time 174la.

To formulate an advantageous driving pulse period length in the dim end of the brightness scale, in an embodiment, it is also advantageous to formulate the duration of the driving pulse period 174 as so that the driving pulse period 174 length is 1%-50% longer than a combined duration of the on-time 174on and launching time 174la. More preferably the driving pulse period 174 length is 4%-20% longer than a combined duration of the on-time 174on and launching time 174la. Most preferably the driving pulse period 174 length is 10%-15% longer than a combined duration of the on-time 174on and launching time 174la. To further avoid the primary light emission and to make the brightness of the display dim through light output of only the secondary emissions 295b, the amplitude voltage 201a of the driving voltage pulse 173 may be equal or more than the electrode threshold voltage 274t and less than 130% of the electrode threshold voltage 274t. Alternatively, the amplitude voltage 201a of the driving voltage pulse 173 may be equal or more than the electrode threshold voltage 274t and less than 110% of the electrode threshold voltage 274t.

In an embodiment, in the method for driving a TFEL display 100, the duration of the cut-off time 174co may be 1 μs-10 μs. This duration for the cut-off time is a valid alternative for all the other embodiments.

In an embodiment, the time behaviour of the driving voltage during the cut-off step is linear. In other words, the driving voltage signal 201 falls in magnitude along a straight line from amplitude voltage 201a at the start of each of the cut-off steps to the zero voltage during the cut-off time 174co.

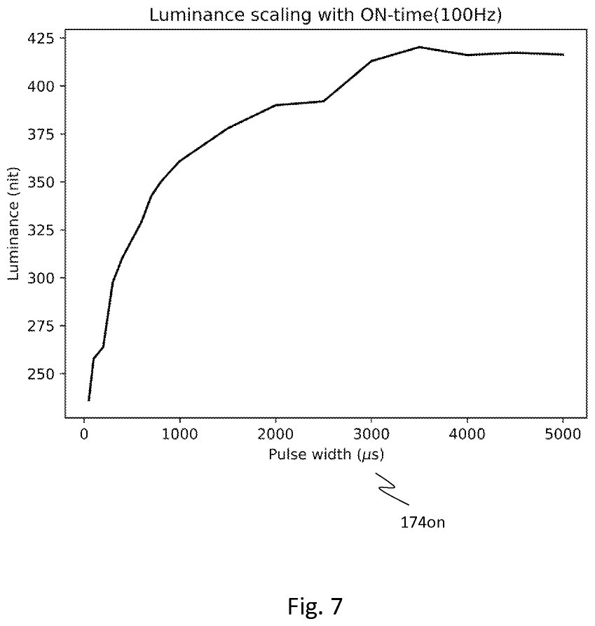

FIG. 7 shows practical measured results of a TFEL display driven with a method according to an aspect of the current invention, and measurements carried out from a relatively large segment electrode. The on-time corresponds to the time the driving pulse period is in the amplitude voltage 201a, the time T_{H}, 174on. Driving frequency is f=100 Hz, giving for driving pulse period 174 the length T=10 000 μs. As the on-time increases, more light is emitted and the brighter the display gets. However, this is not due to a normal pulse width modulation (PWM) of e.g. an OLED display, as the primary and secondary light emissions and the light pulses related thereto are two distinct, nonlinear phenomena in an AC driven TFEL display as explained above. It is also to be noted that the graph does not start from zero in the time scale, but from 100 μs. The luminance increase from the on-time of 100 μs to 500 μs is largely due to the inadequate charging of the display electrode capacitor. At 500 μs on-time, the luminance is approximately 320 nits (cd/m²). From this point on, the increase in luminance to a value of approximately 410 nits is due to the secondary light emission from the extension of the on-time 174on to a value of about 4000 μs. Thus, e.g. based on brightness measurements or by analysing the light emission from the surface of a segment electrode with a fine time-resolution, it is possible to determine the on-time 174on needed charge the inner capacitor 271c to a threshold charging 280t, which is capable of generating a secondary light emission 295b from the inner capacitor 271c related to the said segment electrode. Adjusting the magnitude and brightness of the secondary light emission 295b then becomes a matter of adjusting the on-time 174on, and possibly the launching time 174la and the cut-off time 174co to fit the driving voltage pulse 173 into the driving pulse period 174. Naturally, the same holds also for the primary light emission 295a: Adjusting the magnitude and brightness of the primary light emission 295a is a matter of adjusting the on-time 174on, and possibly the launching time 174la and the cut-off time 174co to fit the driving voltage pulse 173 into the driving pulse period 174. As explained in conjunction with FIG. 6, it is also possible to generate light with secondary light emission 295b only (this result is not shown in FIG. 7, however).

In an aspect of the present invention, an arrangement for driving a thin film electroluminescent (“TFEL”) display 100 is also disclosed. As the aspect is related to an arrangement for driving a TFEL display 100, the elements of the prior art TFEL display 100 in FIG. 1 are valid, with the exception of the generation of the inventive driving voltage signal 201 and the details of the phosphor layer 123 defined in more detail below.

The TFEL display 100 comprises a TFEL display panel 120 comprising a stack of: a first electrode layer 121x comprising a common electrode 121a, a first dielectric layer 122a, a phosphor layer 123, a second dielectric layer 122b, and a segment electrode layer 121y comprising a segment electrode 121b. The common electrode 121a and the segment electrode 121b are at least partially overlapping in an overlapping area 160 along a base plane 161. The TFEL display 100 comprises a driver electronics unit 140 comprising a common electrode driving node 125a and a segment electrode driving node 126a. The TFEL display panel 120 comprises a display electrode capacitor 270c, and the display electrode capacitor 270c comprises the overlapping area 160 of the segment electrode 121b and the common electrode 121a, part of the first dielectric layer 122a bounded by the overlapping area 160, part of the phosphor layer 123 bounded by the overlapping area 160, and part of the second dielectric layer 122b bounded by the overlapping area. The display electrode capacitor 270c also comprises an electrode threshold voltage 274t required for a primary light emission 295a. The TFEL display panel 120 comprises a first dielectric layer-phosphor layer interface 272a between the first dielectric layer 122a and the phosphor layer 123, and a second dielectric layer-phosphor layer interface 272b between the second dielectric layer 122b and the phosphor layer 123. The TFEL display panel 120 comprises an inner capacitor 271c. The inner capacitor 271c comprises part of the first dielectric layer-phosphor layer interface 272a bounded by the overlapping area 160, part of the phosphor layer 123 bounded by the overlapping area 160, and part of the second dielectric layer-phosphor layer interface 272b bounded by the overlapping area 160. The TFEL display 100 comprises also a common electrode connection 125 arranged to electrically connect the common electrode 121a with the common electrode driving node 125a, and a segment electrode connection 126 arranged to electrically connect the segment electrode 121b with the segment electrode driving node 126a. The driving electronics unit 140 is arranged to generate a driving voltage signal 201 comprising driving voltage pulses 173 each having a driving pulse period 174 and an amplitude voltage 201a, the driving voltage signal 201 being generated between the common electrode driving node 125a and the segment electrode driving node 126a. According to an aspect of the invention, the driving voltage signal 201 is arranged according to the method described above in the present application.

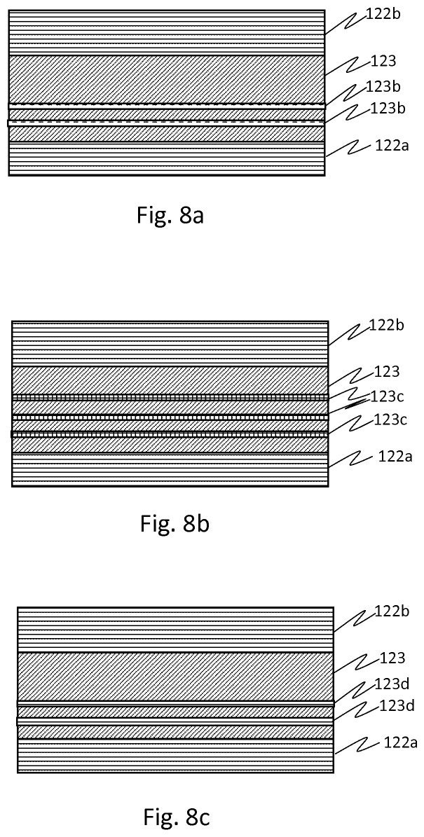

FIG. 8a shows a detailed picture of the phosphor layer 123, first dielectric layer 122a and second dielectric layer 122b. In an embodiment, in an arrangement for driving a thin film electroluminescent display 100, the phosphor layer 123 comprises one or more embedded dielectric layers 123b as in FIG. 8a. Purpose of the embedded dielectric layers 123b is to modify the luminescent and optical characteristics of the phosphor layer 123. By arranging several thin (in the order of 0.1 nm-10 nm) embedded dielectric layers 123b into the phosphor layer 123, the phosphor layer 123 is better optically, esp. in terms of transparency and haze. However, the phosphor is also somewhat dimmer relative to a display without the embedded layers driven with the same excitation. Alternatively, by arranging one embedded dielectric layer 123b into the phosphor layer 123, said embedded dielectric layer 123b having a thickness of 50 nm-200 nm, it has been observed that the brightness increases when excitation is kept the same. Material of the embedded dielectric layer can be e.g. an oxide that can be deposited with ALD with a metal precursor and an oxidising precursor.

Turning to FIG. 8b, in an embodiment, in an arrangement for driving a thin film electroluminescent display 100, the phosphor layer 123 comprises one or more embedded aluminium oxide layers 123c. By arranging several thin (in the order of 0.1 nm-10 nm) embedded aluminium oxide layers 123c into the phosphor layer 123, the phosphor layer 123 is better optically, esp. in terms of transparency and haze.

In another embodiment, the phosphor layer 123 comprises one or more embedded aluminium oxide layers 123c each having a thickness of 0.1 nm-1 nm, considerably improving the phosphor layer 123 in terms of optical performance, esp. in terms of transparency and haze, but the brightness is of the TFEL display is lessened. However, this enables careful control of the dim end of the brightness scale of the TFEL display, esp. if the TFEL display is to be driven with secondary light emissions only.

Aluminium oxide is a very stable dielectric material and readily arranged with the ALD method, e.g. by using trimethylaluminium (TMA) and water as precursors to embed a deposition of one or more layers of aluminium oxide into the ALD deposition of the manganese doped zinc sulfide phosphor layer 123.

In another embodiment, the phosphor layer 123 may comprise just one embedded aluminium oxide layer 123c with a thickness of 50 nm-200 nm. This embodiment makes the display somewhat brighter which is advantageous if the TFEL display is to be driven in the bright end of the brightness scale, with both primary light emission and secondary light emission.

As in FIG. 8c, in an embodiment, in an arrangement for driving a thin film electroluminescent display 100, the phosphor layer 123 comprises one or more embedded aluminium oxide-titanium oxide nanolaminate layers 123d. The embedded aluminium oxide-titanium oxide nanolaminate layers 123d can be arranged similarly as the first and second dielectric layers 122a and 122b, respectively. There can also be only one embedded aluminium oxide-titanium oxide nanolaminate layer 123d with a thickness of 50 nm-200 nm.

It is obvious that for every segment electrode 121b—common electrode combination 121a creating a lateral overlap 160 of said two electrodes, with a common electrode connection 125 arranged between a common electrode driving node 125a and a common electrode 121a, and a segment electrode connection 126 arranged between a segment electrode driving node 126a and a segment electrode 121b, one display electrode capacitor and one inner capacitor is defined. Thus, a TFEL display may comprise one or more display electrode capacitors 270c and one or more inner capacitors 271c, and thus the TFEL display 100 can be provided with one or more picture elements like pixels, symbols or symbol subsections.

The invention has been described above with reference to the examples shown in the figures. However, the invention is in no way restricted to the above examples but may vary within the scope of the claims.

1. A method for driving a thin film electroluminescent (“TFEL”) display, the TFEL display comprising a TFEL display panel comprising a stack of:
a first electrode layer comprising a common electrode,
a first dielectric layer,
a phosphor layer,
a second dielectric layer, and
a segment electrode layer comprising a segment electrode;
the common electrode and the segment electrode at least partially overlapping in an overlapping area along a base plane,
the TFEL display comprising a driver electronics unit comprising:
a common electrode driving node,
a segment electrode driving node;
the TFEL display panel comprising a display electrode capacitor, the display electrode capacitor comprising:
the overlapping area of the segment electrode and the common electrode,
part of the first dielectric layer bounded by the overlapping area,
part of the phosphor layer bounded by the overlapping area,
part of the second dielectric layer bounded by the overlapping area, and
an electrode threshold voltage required for a primary light emission;
the TFEL display panel comprising:
a first dielectric layer-phosphor layer interface between the first dielectric layer and the phosphor layer, and
a second dielectric layer-phosphor layer interface between the second dielectric layer and the phosphor layer;
the TFEL display panel comprising an inner capacitor, the inner capacitor comprising:
part of the first dielectric layer-phosphor layer interface bounded by the overlapping area,
part of the phosphor layer bounded by the overlapping area, and
part of the second dielectric layer-phosphor layer interface bounded by the overlapping area;
the TFEL display comprising:
a common electrode connection arranged to electrically connect the common electrode with the common electrode driving node,
a segment electrode connection arranged to electrically connect the segment electrode with the segment electrode driving node;
wherein the method comprises generating, in the driver electronics unit, a driving voltage signal between the common electrode driving node and the segment electrode driving node, the driving voltage signal comprising driving voltage pulses each having a driving pulse period and an amplitude voltage, the method comprising, in the following order, during the driving pulse period, the steps of:
a) launching, in a launching step lasting a launching time, the driving voltage signal from a zero voltage to the amplitude voltage for launching the driving voltage pulse and for commencing a charging of the inner capacitor,
b) immediately after the launching step, holding, in a holding step lasting an on-time, the driving voltage signal between the common electrode driving node and the segment electrode driving node in the amplitude voltage for continuing the charging of the inner capacitor, and
c) immediately after the holding step cutting, in a cut-off step lasting a cut-off time, the driving voltage signal to a zero voltage, the cut-off step starting after the inner capacitor has been charged to a threshold charging capable of generating a secondary light emission from the inner capacitor.

2. A method for driving a TFEL display according to claim 1, wherein
the inner capacitor comprises an inner threshold voltage required for light emission, and
the cut-off step starts after an inner capacitor voltage of the inner capacitor exceeds the inner threshold voltage capable of generating a secondary light emission from the inner capacitor.

3. A method for driving a TFEL display according to claim 1, wherein
the duration of the launching time is 1 μs-10 μs, and
the amplitude voltage of the driving voltage pulse is equal or more than the electrode threshold voltage.

4. A method for driving a TFEL display according to claim 1, wherein the duration of the on-time is
250 μs-40 ms;
more preferably 1 ms-20 ms; or
most preferably 2 ms-10 ms.

5. A method for driving a TFEL display according to claim 4, wherein the duration of the driving pulse period is 1%-500% longer than a combined duration of the on-time and launching time;
more preferably 10%-50% longer than a combined duration of the on-time and launching time; or
most preferably 20%-30% longer than a combined duration of the on-time and launching time.

6. A method for driving a TFEL display according to claim 1, wherein
the duration of the launching time is long enough to suppress the primary light emission from the display electrode capacitor; or
the duration of the launching time is such that the peak luminance of the primary light emission from the display electrode capacitor is less than the peak luminance of the secondary light emission from the inner capacitor during the driving pulse period; or
the duration of the launching time is 1 ms-20 ms; or
the duration of the launching time is more preferably 2 ms-10 ms; or
the duration of the launching time is most preferably 4 ms-8 ms.

7. A method for driving a TFEL display according to claim 6, wherein the duration of the on-time is
1%-20% of the launching time;
more preferably 2%-10% of the launching time; or
most preferably 5%-8% of the launching time.

8. A method for driving a TFEL display according to claim 7, wherein the duration of the driving pulse period is
1%-50% longer than a combined duration of the on-time and launching time (174la);
more preferably 4%-20% longer than a combined duration of the on-time and launching time; or
most preferably 10%-15% longer than a combined duration of the on-time and launching time.

9. A method for driving a TFEL display according to claim 6, wherein
the amplitude voltage of the driving voltage pulse is equal or more than the electrode threshold voltage and less than 130% of the electrode threshold voltage; or
the amplitude voltage of the driving voltage pulse is equal or more than the electrode threshold voltage and less than 110% of the electrode threshold voltage.

10. An arrangement for driving a thin film electroluminescent display, the TFEL display comprising a TFEL display panel comprising a stack of:
a first electrode layer comprising a common electrode,
a first dielectric layer,
a phosphor layer,
a second dielectric layer, and
a segment electrode layer comprising a segment electrode;
the common electrode and the segment electrode at least partially overlapping in an overlapping area along a base plane, the TFEL display comprising a driver electronics unit comprising:
a common electrode driving node,
a segment electrode driving node;
the TFEL display panel comprising a display electrode capacitor, the display electrode capacitor comprising:
the overlapping area of the segment electrode and the common electrode,
part of the first dielectric layer bounded by the overlapping area,
part of the phosphor layer bounded by the overlapping area,
part of the second dielectric layer bounded by the overlapping area, and
an electrode threshold voltage required for primary light emission;
the TFEL display panel comprising:
a first dielectric layer-phosphor layer interface between the first dielectric layer and the phosphor layer,
a second dielectric layer-phosphor layer interface between the second dielectric layer and the phosphor layer;
the TFEL display panel comprising an inner capacitor, the inner capacitor comprising:
part of the first dielectric layer-phosphor layer interface bounded by the overlapping area,
part of the phosphor layer bounded by the overlapping area, and
part of the second dielectric layer-phosphor layer interface bounded by the overlapping area;
the TFEL display comprising:
a common electrode connection arranged to electrically connect the common electrode with the common electrode driving node,
a segment electrode connection arranged to electrically connect the segment electrode with the segment electrode driving node;
the driver electronics unit arranged to generate a driving voltage signal comprising driving voltage pulses each having a driving pulse period and an amplitude voltage, the driving voltage signal being generated between the common electrode driving node and the segment electrode driving node,
wherein the driving voltage signal is arranged according to claim 1.

11. An arrangement for driving a thin film electroluminescent (“TFEL”) display according to claim 10, wherein
the phosphor layer comprises one or more embedded dielectric layers; or
the phosphor layer comprises one or more embedded aluminium oxide layers; or
the phosphor layer comprises one or more embedded aluminium oxide-titanium oxide nanolaminate layers.
